(19) United States
(12) Patent Application Publication
(10) Pub. No.: US 2020/0033543 A1
(43) Pub. Date: Jan. 30, 2020

(54) OPTICAL FIBRE JOINT

(71) Applicant: British Telecommunications Public Limited Company, London (GB)

(72) Inventors: Malcolm CAMPBELL, London (GB); Ian HUNTER, London (GB)

(73) Assignee: British Telecommunications Public Limited Company, London (GB)

(21) Appl. No.: 16/338,276

(22) PCT Filed: Oct. 2, 2017
(86) PCT No.: PCT/EP2017/075023

§ 371 Date: Mar. 29, 2019

(30) Foreign Application Priority Data
Sep. 30, 2016 (EP) 16191657.2

(51) Int. Cl. G02B 6/44; G02B 6/36

(52) U.S. Cl. CPC G02B 6/4446; G02B 6/4454; G02B 6/4415; G02B 6/3604

(57) ABSTRACT

An optical fiber joint including a support member, a plurality of optical fiber storage trays connected to the support member, where an optical splitter is received within one of the optical fiber storage trays, the optical splitter comprising one or more input optical fibers and a plurality of output optical fibers wherein, in use the or each spliced optical splitter output optical fibers and respective optical splice and further optical fiber are stored within an optical fiber storage tray; and the or each unspliced optical splitter output optical fibers are stored within an optical fiber storage apparatus which is external to the plurality of optical fiber storage trays.

### CROSS-REFERENCE TO RELATED APPLICATION

The present application is a National Phase entry of PCT Application No. PCT/EP2017/075023, filed Oct. 2, 2017, which claims priority from EP Patent Application No. 16191657.2 filed Sep. 30, 2016 each of which is hereby fully incorporated herein by reference.

### TECHNICAL FIELD

The present disclosure relates to an optical fiber joint, and in particular to an optical fiber joint for use in passive optical networks.

### BACKGROUND

Telecommunications network operators have installed large amounts of optical fiber, particularly in core and backhaul networks, where optical fiber has provide very significant performance and cost advantages over coaxial cable and microwave transmission links. In access networks, advances in digital subscriber line (DSL) technology have made it more difficult to justify wide scale investment in fiber. However, there is a trend for access networks to move from all copper networks to hybrid fiber-copper networks utilizing fiber to the cabinet (FTTC) and fiber to the node (FTTN) network architectures, and towards all fiber networks, such as PONs (passive optical networks), which provide fiber to the premises (FTTP). PON networks require optical fiber joints which can store one or more optical splitters. The optical splitter will comprise an input fiber and a plurality of output fibers, typically 8, 16 or 32 output fibers. Each of these fibers needs to be spliced to a respective fiber from a respective input or output cable and these optical splices also need to be stored securely, such that the fibers are protected so that there is no mechanical damage to the fiber and that no short-term optical losses are induced. FIGS. 1 & 2 show schematic depictions of a known optical fiber joint 100: FIG. 1 shows a front view and FIG. 2 shows a side view of the optical fiber joint. The optical fiber joint 100 comprises a base 110 and a cover 120 which can be removably connected to the base. A spine 130 is connected to the base 110 and a plurality of optical fiber storage trays 140 are connected to the spine. The base comprises one or more input cable ports 112 and one or more output cable ports 114. FIGS. 1 & 2 shows that one input fiber cable 200 is received within an input cable port 112 and that two output fiber cables 220 are received within respective output cable ports 114. The input fiber cable comprises a plurality of fiber cable elements 202, each of which comprises one or more optical fibers. When the input fiber cable is routed into the joint, the sheath of the cable is removed and the fiber cable elements are stored within the optical fiber joint. One or more of the fiber cable elements will be routed to one or more of the optical fiber storage trays, such that the optical fibers held within the fiber cable element(s) can be fed into a storage tray. These optical fibers will be spliced to an input fiber of an optical splitter or will be stored within a storage tray for later use. The multiple output fibers from the optical splitter (or splitters) will be spliced to an optical fiber from an output fiber cable 220. When the FTTP network is deployed, it may be that a splitter with 32 output fibers is used to provide service to just several customers such that there are many optical splitter output optical fibers which are initially unused. These unused output optical fibers will be stored, using a plurality of optical fiber storage trays.

### SUMMARY

According to a first aspect of the disclosure, there is provided an optical fiber joint comprising: a support member, a plurality of optical fiber storage trays connected to the support member, wherein an optical splitter is received within one of the optical fiber storage trays, the optical splitter comprising one or more input optical fibers and a plurality of output optical fibers wherein, in use: the or each spliced optical splitter output optical fibers and respective optical splice and further optical fiber are stored within an optical fiber storage tray; and the or each unspliced optical splitter output optical fibers are stored within an optical fiber storage apparatus which is external to the plurality of optical fiber storage trays.

The optical fiber joint may comprise a plurality of optical fiber storage apparatuses, with the or each optical fiber storage apparatus being connected to the support member. The or each optical fiber storage apparatus may be connected to the opposed side of the support member with respect to the plurality of optical fiber storage trays.

A plurality of optical splitters may be received within the optical fiber storage trays and each of the plurality of optical splitters may be received within a respective optical fiber storage tray. The unspliced optical splitter output optical fibers from the or each optical splitter may be stored together in a respective optical fiber storage apparatus. A single optical splice is stored in one or more of the optical fiber storage trays and/or two optical splices are stored in one or more of the optical fiber storage trays. The optical fiber joint may be further configured to receive one or more input optical fiber cables and one or more output optical fiber cables.

According to a second aspect of the disclosure, there is provided a communications network comprising an optical fiber joint comprising: a support member, a plurality of optical fiber storage trays connected to the support member, wherein an optical splitter is received within one of the optical fiber storage trays, the optical splitter comprising one or more input optical fibers and a plurality of output optical fibers wherein, in use: the optical fiber joint receives one or more input optical fiber cables and one or more output optical fiber cables; one or more optical fibers from the output optical fiber cables are optically spliced to respective optical splitter output optical fibers; the or each optical splice and the associated optical fibers are stored within an optical fiber storage tray and the unspliced optical splitter output optical fibers are stored within an optical fiber storage apparatus which is external to the plurality of optical fiber storage trays.

### BRIEF DESCRIPTION OF THE FIGURES

In order that the present disclosure may be better understood, embodiments thereof will now be described, by way of example only, with reference to the accompanying drawings in which:

FIG. 1 shows a schematic depiction of the front view of a known optical fiber joint;

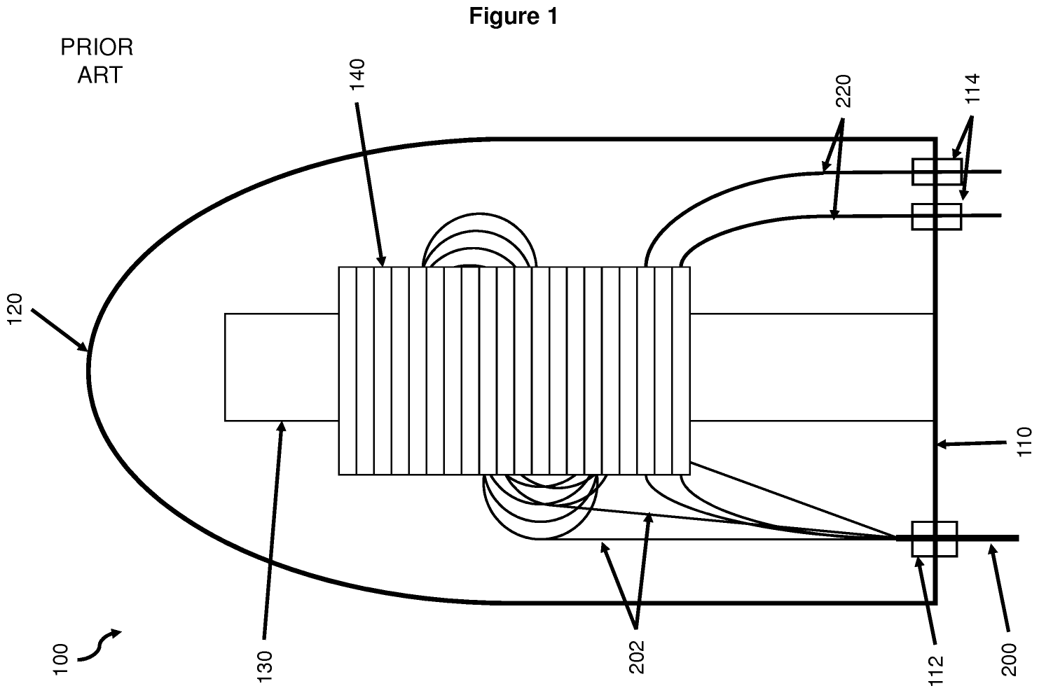

FIG. 2 shows a schematic depiction of the side view of a known optical fiber joint;

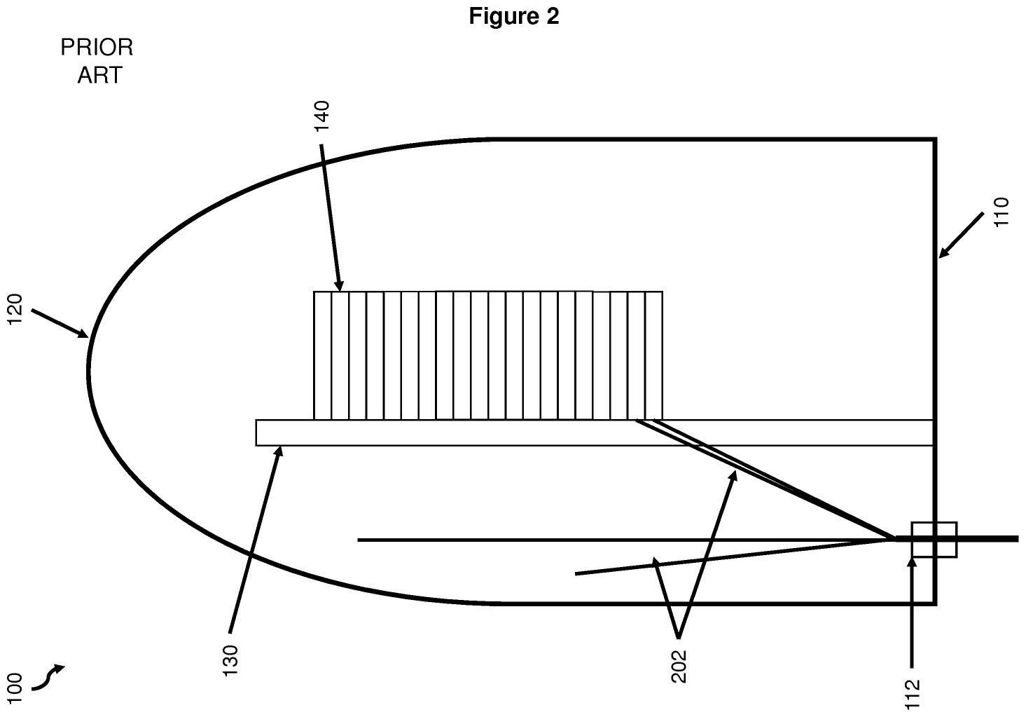

FIG. 3 shows a schematic depiction of the side view of an optical fiber joint according to an embodiment of the present disclosure;

FIG. 4 shows a schematic depiction of the rear view of an optical fiber joint according to an embodiment of the present inv disclosure;

FIG. 5 shows a further schematic depiction of the rear view of an optical fiber joint according to an embodiment of the present disclosure;

FIG. 6 shows schematic depictions of a number of possible designs for the optical fiber storage apparatuses; and

FIG. 7 shows a schematic depiction of the rear view of an optical fiber joint 100′ according to this further embodiment of the present disclosure.

### DETAILED DESCRIPTION OF EMBODIMENTS

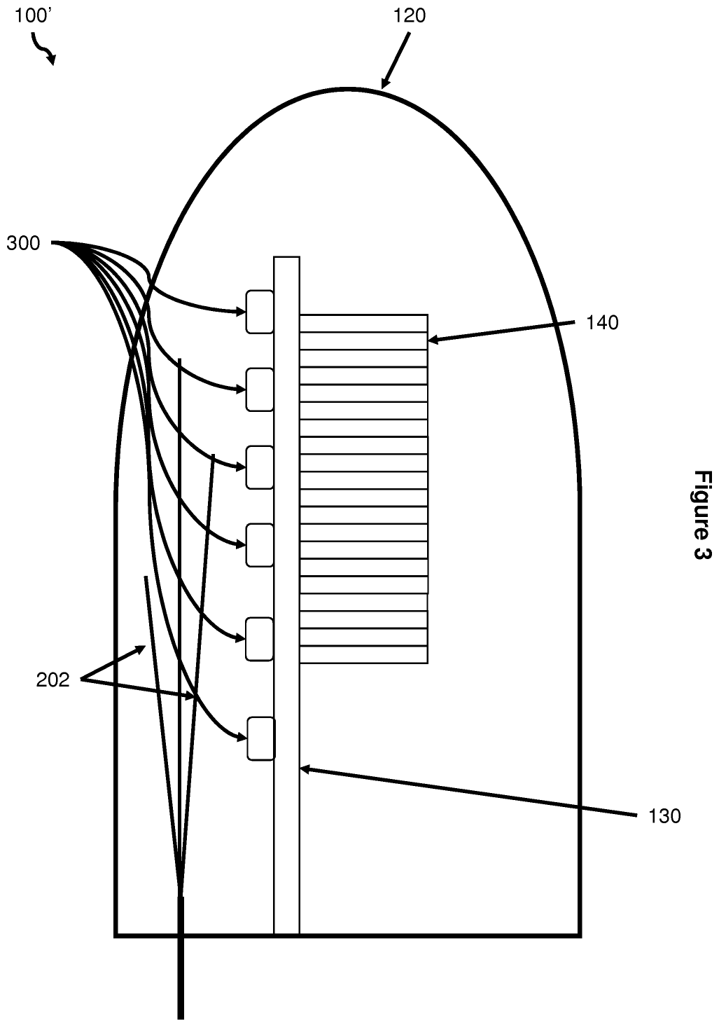

FIG. 3 shows a schematic depiction of the side view of an optical fiber joint 100′ according to an embodiment of the present disclosure, which comprises a base 110 and a cover 120 which can be removably connected to the base. A spine 130 is connected to the base 110: a plurality of optical fiber storage trays 140 are supported from the spine 130. The base comprises one or more input cable ports 112 and one or more output cable ports 114. One or more fiber splitters are received within a respective optical fiber storage tray.

A plurality of optical fiber storage apparatuses 300 are received on the spine 130: in some embodiments the optical fiber storage apparatuses 300 are located on the opposite side of the spine from the plurality of optical fiber storage trays 140. When the one or more fiber splitters are installed into the optical fiber joint (it would be preferred if this installation were to occur within the controlled factory environment of the joint manufacturer but it should be understood that the optical splitter may be installed into the joint by an engineer in the field) the output fibers of the optical splitter are routed from the storage tray which houses the splitter to an optical fiber storage apparatus.

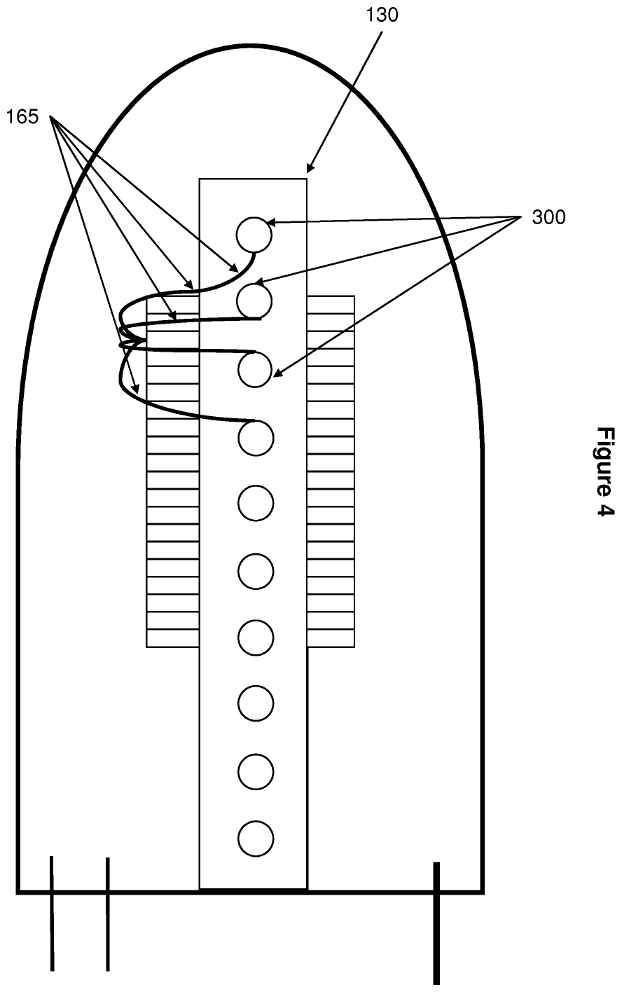

FIG. 4 shows a schematic depiction of the rear view of an optical fiber joint 100′ according to an embodiment of the present invention in which the 16 output fibers of an optical splitter are routed to four different optical fiber storage apparatuses, with each optical fiber storage apparatus storing a group of 4 fibers 165. Before any customers are connected to the joint, the only optical fiber storage trays which are occupied are those which are storing an optical splitter. For the sake of clarity, FIG. 4 shows only a single fiber splitter: it will be understood that an optical fiber joint may store several optical splitters, dependant on the size of the optical fiber joint and the number of outputs of the optical splitters.

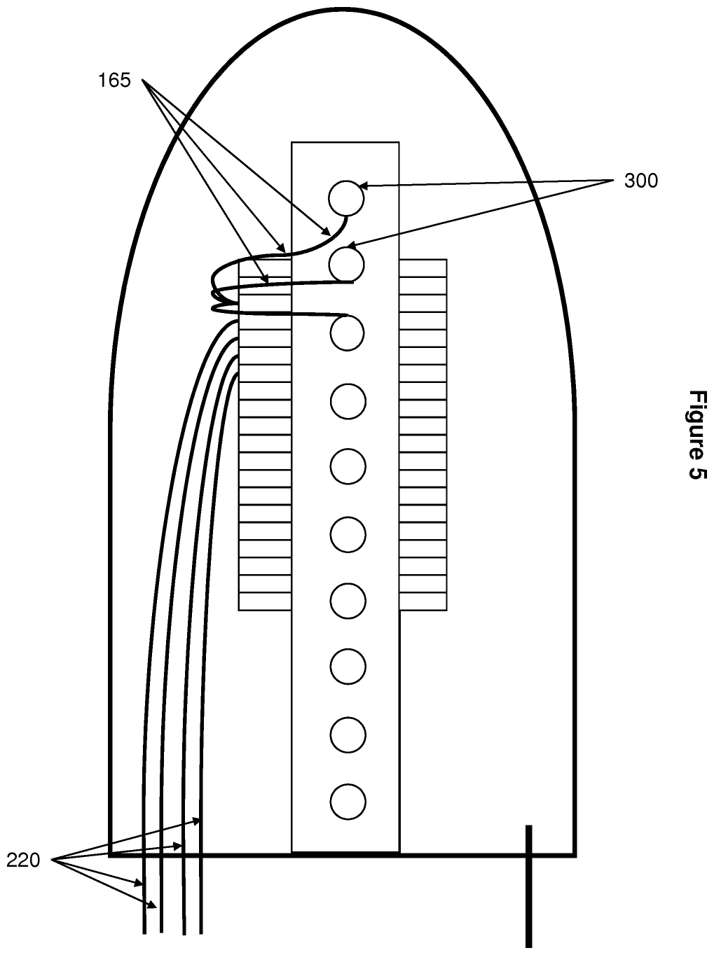

FIG. 5 shows a further schematic depiction of the rear view of an optical fiber joint 100′ according to an embodiment of the present disclosure. FIG. 5 shows the optical fiber joint 100′ when four customers have been connected to the optical splitter. It can be seen that now only three of the groups of 4 optical fibers are stored within an optical fiber storage apparatus. The other four splitter output fibers will be spliced to a respective output optical fiber cable 220, with each of the optical splices being stored in an optical fiber storage tray.

As further customers are connected to the optical splitter, the fibers stored within the optical fiber storage apparatuses will be removed from the optical fiber storage apparatuses and will be spiced to a respective output optical fiber cable, such that the plurality of optical fiber storage trays will be storing one or more optical splitters and a plurality of optical fiber splices. The unspliced optical splitter output fibers are stored in one of the optical fiber storage apparatuses and not in an optical fiber storage tray.

Known optical fiber joints, and associated jointing techniques, lead to inefficient use of the space within a joint. On deployment, the optical fiber storage trays are used to store the output fibers of the optical splitter. As customers are connected to the network, the optical splitter fibers are transferred to further storage trays in order to be spliced. This leads to a number of splice trays becoming unusable. The length of the joint, and thus the number of fiber storage trays which can be connected to the spine, is limited by the size of the underground footway box within which the joint will be housed.

The use of the fiber storage apparatuses, in accordance with the teaching of the present disclosure, should allow for more efficient utilization of the space within the joint as the optical fiber storage trays are only used to store optical splitters and the splices of optical splitter output fibers. Optical splitter output fibers which are not yet spliced are stored in one of the optical fiber storage apparatuses, outside of the optical fiber storage trays.

By locating the optical fiber storage apparatuses on the rear of the spine, that is on the opposite side of the spine from where the fiber storage trays are connected to the spine, the addition of the optical fiber storage apparatuses does not reduce the amount of space that could be made available for optical fiber storage trays. The space behind the rear of the spine is conventionally used to store excess lengths of the fiber cable elements of the input fiber cable(s). By securing the optical fiber storage apparatuses to the spine, there should not be any interference between the optical fiber storage apparatuses and any stored lengths of fiber cable elements and/or cable.

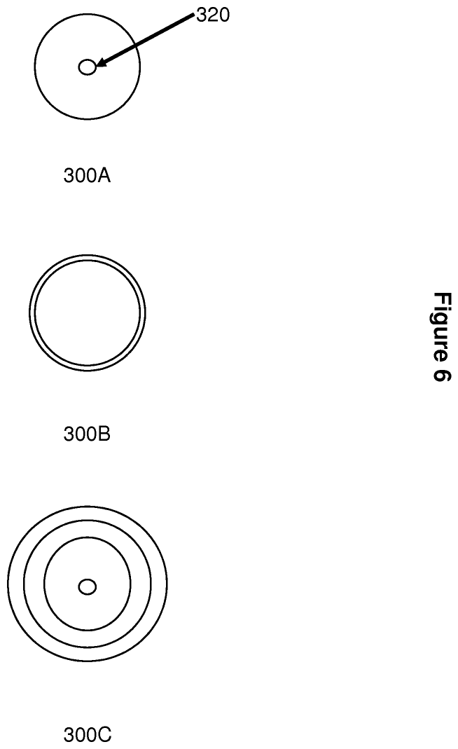

FIG. 6 shows schematic depictions of a number of possible designs for the optical fiber storage apparatuses 300. For example, the fiber storage apparatus 300A may take the form of a simple circular mandrel, around which the optical splitter output fibers can be coiled. The group of optical splitter output fibers may be secured to the outer surface using a small piece of tape, for example.

Alternatively, the fiber storage apparatus 300B may have an annular form such that the optical splitter output fiber can be coiled around the external face of the optical fiber storage apparatus or the optical splitter output fibers can be stored within the space defined by the optical fiber storage apparatus. In a further alternative, the optical fiber storage apparatus 300C may comprise an annular ring arranged around a mandrel, defining an annular region within which the optical splitter output fibers can be stored. In the case of the optical fiber storage apparatus 300B & 300C a slit may be formed within the annular ring in order that the optical splitter output fibers can be inserted into and removed from the optical fiber storage apparatus.

A single optical fiber storage apparatus may simultaneously store multiple groups of optical splitter output fibers. For example, the optical fiber storage apparatus may have a plurality of circumferential grooves formed in the surface of the optical fiber storage apparatus such that a group of optical splitter output fibers can be coiled within a respective groove. Alternatively, one or more ‘collars’ could be placed around the mandrel to define a number of different zones for the optical fiber storage apparatus such that a zone could receive one of the groups of fibers.

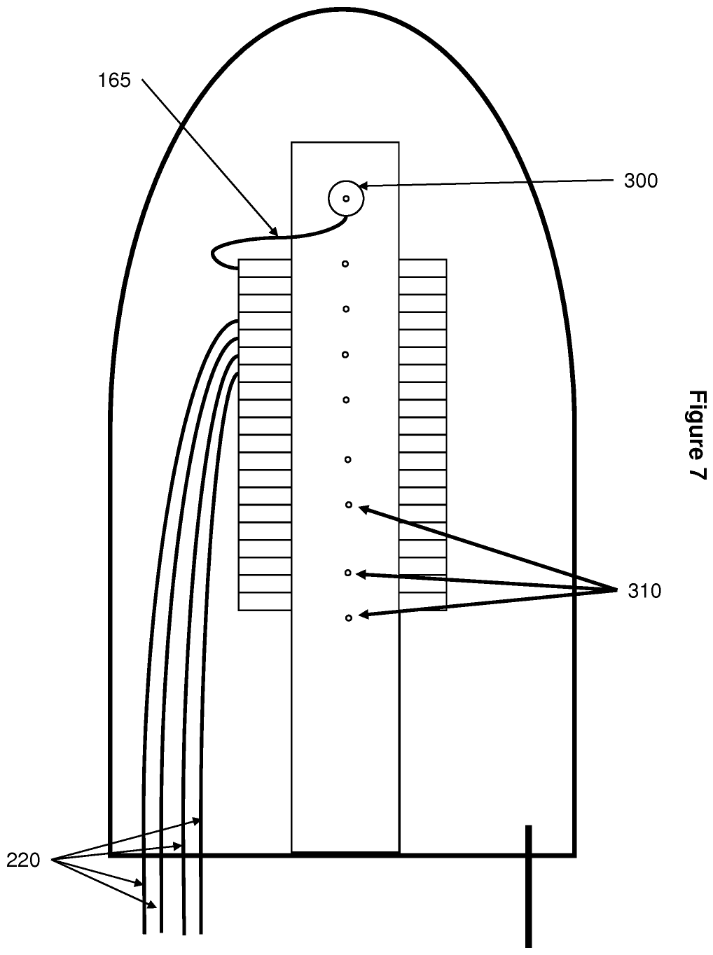

In a further embodiment of the present disclosure the node may be installed or provided without any optical splitters installed. Subsequently, one or more optical splitters may be installed into an optical fiber storage tray. For each of the optical splitters to be installed, the input and output optical fibers of the splitter may be stored within an optical fiber storage apparatus. When the optical splitter is installed into an optical fiber storage tray then the respective optical fiber storage apparatus 300 may be attached to a pin or projection 310 located on the spine. The optical apparatus 300 may be as described above with reference to FIG. 6 with a complementary recess 320 which can receive the projection 310 so that the optical fiber storage apparatus 300 can be securely mounted on the spline. A push-fit mechanism can be provided such that the optical fiber storage apparatus 300 can be removably mounted on the spine. FIG. 7 shows a schematic depiction of the rear view of an optical fiber joint 100′ according to this further embodiment of the present disclosure in which a plurality of projections 310 are provided on the rear of the spine. It can be seen that an optical fiber storage apparatus 300 has been connected to the uppermost projection, with some of the optical fibers 165 being routed to a fiber storage tray. Such an arrangement allows splitters to be installed as needed, with the necessary number of fibers being installed as and when required. Fibers which are not yet needed can be stored safely within an optical fiber storage apparatus.

It will be readily apparent to the person skilled in the art that the optical fiber storage apparatus may take one of many forms and that the exact form of the optical fiber storage apparatus is not critical to the operation of the present disclosure.

It will be understood that each of the plurality of optical fiber storage trays may store 1 or 2 splices per tray (or even a larger number of splices). It is well known in the field that optical fiber in joints need some form of protection or management in order to minimize mechanical damage or abrasion and to minimize transient optical losses which may be induced by sudden movement of a fiber. Although not shown in the Figures, it should be understood that the output fibers of the or each optical splitter will be protected by some form of fiber management, for example being housed within a bend limiting tube, whilst being routed from the fiber storage trays to the fiber storage apparatuses.

According to one aspect, the present disclosure provides an optical fiber joint comprising a support member, a plurality of optical fiber storage trays connected to the support member, where an optical splitter is received within one of the optical fiber storage trays, the optical splitter comprising one or more input optical fibers and a plurality of output optical fibers wherein, in use the or each spliced optical splitter output optical fibers and respective optical splice and further optical fiber are stored within an optical fiber storage tray; and the or each unspliced optical splitter output optical fibers are stored within an optical fiber storage apparatus which is external to the plurality of optical fiber storage trays.

1. An optical fiber joint comprising:
a support member; and
a plurality of optical fiber storage trays connected to the support member, wherein an optical splitter is received within one of the optical fiber storage trays, the optical splitter comprising one or more input optical fibers and a plurality of output optical fibers,
wherein, in use, spliced optical splitter output optical fibers and a respective optical splice and a further optical fiber are stored within one of the plurality of an optical fiber storage trays, and unspliced optical splitter output optical fibers are stored within an optical fiber storage apparatus which is external to the plurality of optical fiber storage trays.

2. The optical fiber joint according to claim 1, wherein the optical fiber joint further comprises a plurality of optical fiber storage apparatuses.

3. The optical fiber joint according to claim 2, wherein the plurality of optical fiber storage apparatuses is connected to the support member.

4. The optical fiber joint according to claim 3, wherein the plurality of optical fiber storage apparatuses is connected to an opposed side of the support member with respect to the plurality of optical fiber storage trays.

5. The optical fiber joint according to claim 1, wherein a plurality of optical splitters is received within the plurality of optical fiber storage trays.

6. The optical fiber joint according to claim 5, wherein each of the plurality of optical splitters is received within a respective one of the plurality of optical fiber storage tray.

7. The optical fiber joint according to claim 1, wherein the unspliced optical splitter output optical fibers from the optical splitter are stored together in a respective optical fiber storage apparatus.

8. The optical fiber joint according to claim 1, wherein a single optical splice is stored in one or more of the plurality of optical fiber storage trays.

9. The optical fiber joint according to claim 1, wherein two optical splices are stored in one or more of the plurality of optical fiber storage trays.

10. The optical fiber joint according to claim 1, wherein the optical fiber joint is configured to receive one or more input optical fiber cables and one or more output optical fiber cables.

11. A communications network comprising:
an optical fiber joint comprising:
a support member, a plurality of optical fiber storage trays connected to the support member, wherein an optical splitter is received within one of the plurality of optical fiber storage trays, the optical splitter comprising one or more input optical fibers and a plurality of output optical fibers, wherein, in use,
the optical fiber joint receives one or more input optical fiber cables and one or more output optical fiber cables,
one or more optical fibers from the output optical fiber cables are optically spliced to respective optical splitter output optical fibers,
optical splices and associated optical fibers are stored within one of the plurality of optical fiber storage trays, and
unspliced optical splitter output optical fibers are stored within an optical fiber storage apparatus which is external to the plurality of optical fiber storage trays.
